(19) United States
(12) Patent Application Publication
(10) Pub. No.: US 2020/0304653 A1
(43) Pub. Date: Sep. 24, 2020

(54) DATA COLLECTION SYSTEM AND DATA COLLECTION METHOD

(71) Applicant: FUJI XEROX CO., LTD., Tokyo (JP)

(72) Inventor: Kohei TANAKA, Kanagawa (JP)

(73) Assignee: FUJI XEROX CO., LTD., Tokyo (JP)

(21) Appl. No.: 16/560,987

(22) Filed: Sep. 4, 2019

(30) Foreign Application Priority Data
Mar. 19, 2019 (JP) 2019-051381

(51) Int. Cl. H04N 1/00

(52) U.S. Cl. CPC H04N 1/00244; H04N 2201/0094; H04N 1/0097; H04N 1/00326

(57) ABSTRACT

A data collection system includes one or more radio modules that are respectively detachably mounted on devices unconnected to a network and are enabled to transmit, via radio communication, raw data that is obtained by reading a signal from an input and output port of each of the devices, an image forming apparatus including an image forming unit that forms an image, a hub unit that collects the raw data from the one or more radio modules, and a transmitting unit that transmits the collected raw data, and a central server that collects information generated by the devices by performing a pre-process responsive to each of the devices on the raw data transmitted from the image processing apparatus.

### CROSS-REFERENCE TO RELATED APPLICATIONS

This application is based on and claims priority under 35 USC 119 from Japanese Patent Application No. 2019-051381 filed Mar. 19, 2019.

### BACKGROUND

### (i) Technical Field

The present disclosure relates to a data collection system and a data collection method.

### (ii) Related Art

Japanese Unexamined Patent Application Publication (Translation of PCT Application) No. 2018-507451 discloses an Internet of things (IoT) system including an IoT hub. Using the IoT system, a user may produce a library program code with a software development kit (SDK) provided and implements the code on the IoT hub. The user may thus provide systems supporting a variety of IoT devices.

An image forming apparatus forming an image may be used as an edge server in a system. On each of network-unconnected devices deployed around the image forming apparatus, a manufacturer of the device may develop data collection hardware or software on a per device basis in the system. Since the configuration of the image forming apparatus having a variety of functions is complex, the development involves deep knowledge of implementing the system. A larger amount of man-hour is used in development when the image processing apparatus is used as an edge server than when an edge server having another apparatus is used.

### SUMMARY

Aspects of non-limiting embodiments of the present disclosure relate to reducing development man-hour more when an image forming apparatus having an image forming unit is used as an edge server than when data collection hardware and software are developed on a per device basis.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a data collection system. The data collection system includes one or more radio modules that are respectively detachably mounted on devices unconnected to a network and are enabled to transmit, via radio communication, raw data that is obtained by reading a signal from an input and output port of each of the devices, an image forming apparatus including an image forming unit that forms an image, a hub unit that collects the raw data from the one or more radio modules, and a transmitting unit that transmits the collected raw data, and a central server that collects information generated by the devices by performing a pre-process responsive to each of the devices on the raw data transmitted from the image processing apparatus.

### BRIEF DESCRIPTION OF THE DRAWINGS

Exemplary embodiment of the present disclosure will be described in detail based on the following figures, wherein:

FIG. 1 illustrates the entire configuration of a data collection system of an exemplary embodiment of the disclosure;

FIG. 2 is an electrical block diagram of an unconnected device and a radio module illustrated in FIG. 1;

FIG. 3 is an electrical block diagram of an image forming apparatus in FIG. 1;

FIG. 4 is an electrical block diagram of a central server in FIG. 1;

FIG. 5 illustrates an example of a data structure of module management information in FIG. 4;

FIG. 6 diagrammatically illustrates a data flow when the radio module is installed;

FIG. 7 diagrammatically illustrates a data flow when raw data is read; and

FIG. 8 diagrammatically illustrates a data flow when the raw data is simultaneously transmitted.

### DETAILED DESCRIPTION

A data collection system 10 of an exemplary embodiment of the disclosure performing a data collection method is described with reference to the drawings. The disclosure is not limited to the exemplary embodiment and may be modified within the range without departing from the scope of the disclosure. Elements of the data collection system may be flexibly combined in a technically consistent fashion.

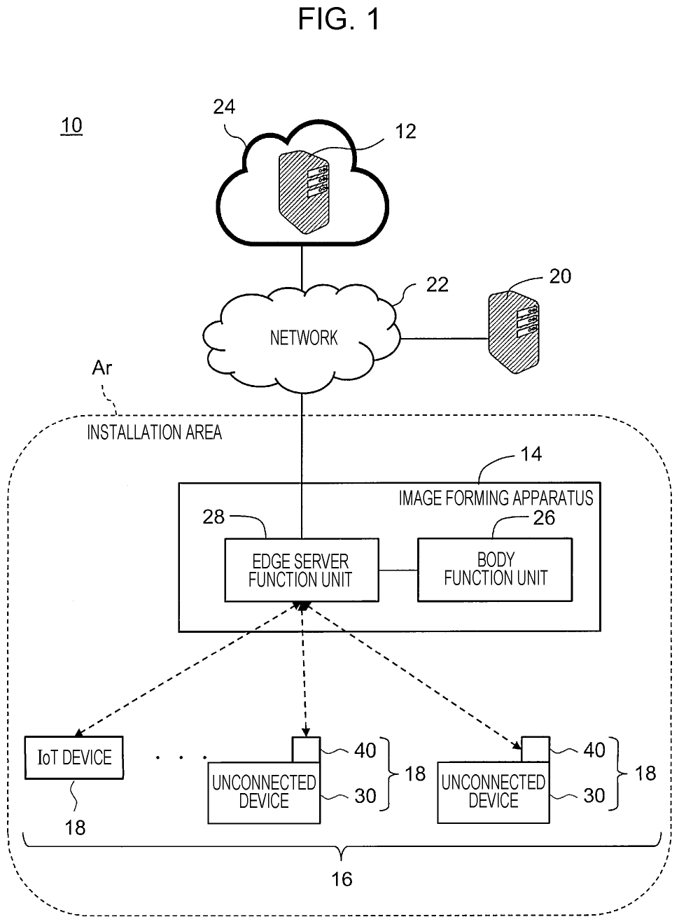

FIG. 1 illustrates the entire configuration of the data collection system 10 of an exemplary embodiment of the disclosure. The data collection system 10 provides an image forming service to provide an image bearing object to a user within an installation area Ar and a data collection service to collect and analyze data successively generated within the installation area Ar.

The data collection system 10 includes a central server 12, image forming apparatus 14 serving as an edge server, device group 16 including multiple Internet of things (IoT) devices 18, and trusting server 20. The image forming apparatus 14 and the device group 16 are installed in the installation area Ar, such as in an office. The image forming apparatus 14 bilaterally communicates with the central server 12 via a network 22. Although FIG. 1 illustrates the single image forming apparatus 14, multiple image forming apparatuses 14 may be installed in the single installation area Ar. Although FIG. 1 illustrates the single installation area Ar, another installation area different from the installation area Ar may also be set up.

The central server 12 includes one or more server computers over a cloud 24. The central server 12 collects data from the image forming apparatus 14 serving as an edge server and performs a variety of process to use the data. The central server 12 may be a cloud server or a on-premise server.

The image forming apparatus 14 may be a multi-function printer (MFP) that performs at least one of a print function, copy function, scan function, fax function, and data transmission function. The image forming apparatus 14 includes a body function unit 26 that performs functions for the image forming service and an edge server function unit 28 for the data collection service.

The IoT device 18 supports a function of generating data when a variety of functions implemented on the image forming apparatus 14 are performed and supports a communication function to wiredly or wirelessly transmit generated data. The IoT device 18 may be a stationary device installed in the installation area Ar (such as a computer, a communication device, office apparatus, lighting device, air-conditioning device, or measuring device) or a portable device carried into the installation area Ar (such as a laptop, tablet, smart phone, or wearable device). The image forming apparatus 14 including the body function unit 26 may be considered to be the IoT device 18.

The IoT device 18 may be one or more standalone devices (hereinafter referred to as unconnected devices 30) that are unconnected to any network and operates standalone. The unconnected device 30 has a radio module 40 that wirelessly communicates with the image forming apparatus 14 and thus operates as the IoT device 18. A data collection service provider may lend the radio module 40 to an manufacturer or distributor of the IoT device 18 and thus provides a “collection agency service” to collect data by using the data collection system 10.

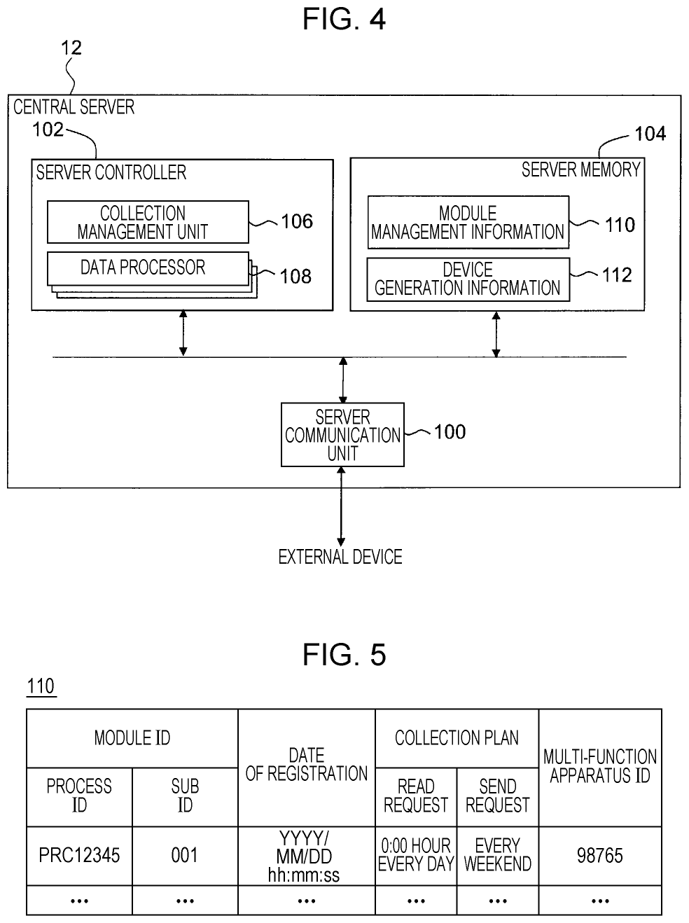

The trusting server 20 is owned by a truster of the collection agency service (for example, the manufacturer or distributor of the unconnected device 30) and is enabled to acquire data from the central server 12 via the network 22. The trusting server 20 thus acquires information (device generation information 112 described below with reference to FIG. 4) generated by the unconnected device 30.

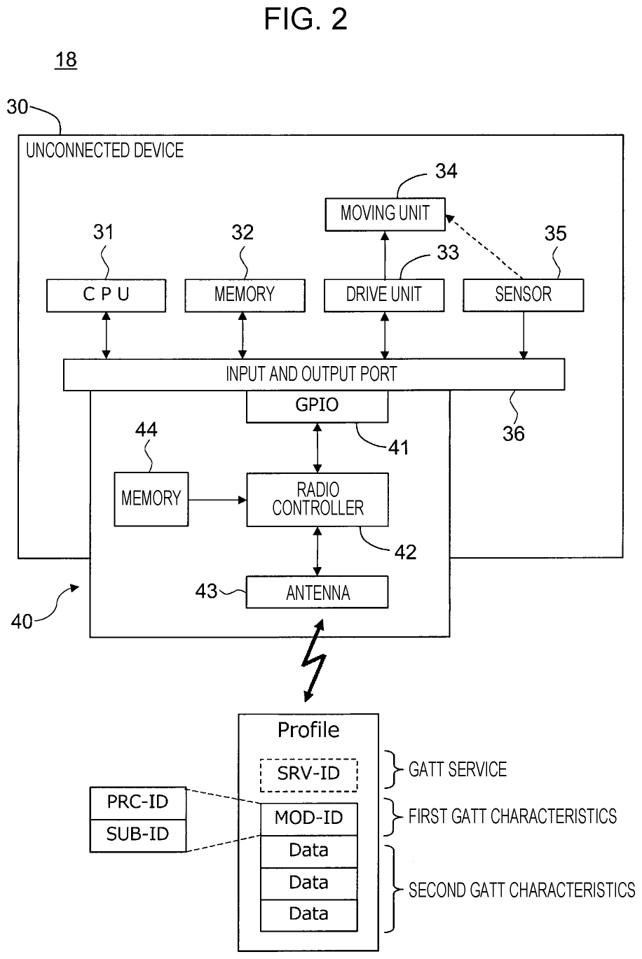

FIG. 2 is an electrical block diagram of the unconnected device 30 and the radio module 40 illustrated in FIG. 1. The unconnected device 30 may include a variety of devices installed around the image forming apparatus 14 and may include a shredder, air-conditioning device, and/or illumination device. The radio module 40 is a versatile module and may be mounted on a variety of devices different in terms of function and application.

The unconnected device 30 includes a central processing unit (CPU) 31, memory 32, drive unit 33, moving unit 34, and sensor 35. The elements in the unconnected device 30 are electrically connected to each other via an input and output port 36. If the unconnected device 30 is a shredder, the drive unit 33 is an electric motor that rotates in response to a control signal from the CPU 31, the moving unit 34 is a rotary cutter, and the sensor 35 is a revolution sensor that measures a rotational speed of the rotary cutter.

The radio module 40 includes a general-purpose input and output (GPIO) terminal 41, radio controller 42, antenna 43, and non-volatile memory 44. The GPIO terminal 41 is connectable with the input and output port 36 of the unconnected device 30. The radio controller 42 performs a variety of control operations to perform radio communications by using the antenna 43. The non-volatile memory 44 stores multiple pieces of identification (ID) information used to provide the collection agency service. The radio modules 40 are respectively detachably attached to the unconnected devices 30 and are enabled to transmit, via radio communication, raw data obtained by reading a signal from the input and output port 36 of the unconnected device 30.

The radio module 40 mounted on the unconnected device 30 performs generic attribute (GATT) profile communication with the image forming apparatus 14. The GATT profile communication is performed by using a profile that is defined by a GATT profile or GATT.

The GATT profile includes one or more services (hereinafter referred to as GATT service) and characteristic associated with each GATT service (hereinafter referred to as GATT characteristic). The GATT service and the GATT characteristic are respectively tagged with universally unique identifiers (UUIDs). The UUIDs of the GATT service and GATT characteristic are unique values stored on the memory 44.

The identification information of the radio module 40 (hereinafter referred to as a “module ID”) is stored in a data region of a first GATT characteristic. The module ID is ID information that is produced by successively linking the identification information of a pre-process (process ID) and a sub ID whose addition is optional. The process ID may be a value stored on the memory 44. The sub ID may be set by setting a jumper pin on the GPIO terminal 41.

Raw data read from the unconnected device 30 via the input and output port 36 and the GPIO terminal 41 (for example, a control signal from the CPU 31 or a measurement signal from the sensor 35) is stored in a data region of a second GATT characteristic. One or more UUIDs may be assigned to the second GATT characteristic. An amount data transmittable via one session of communication is increased by increasing the number of UUIDs.

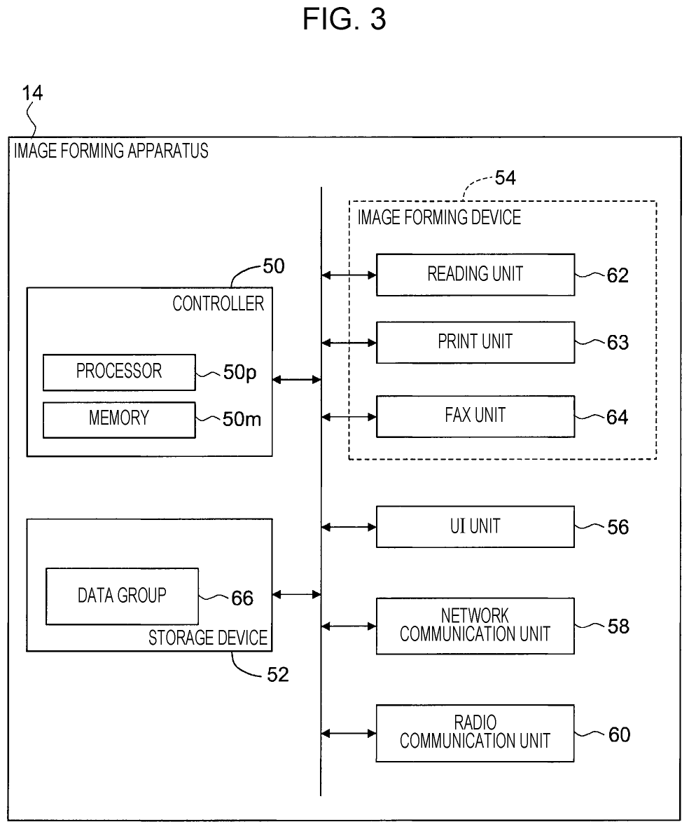

FIG. 3 is an electrical block diagram of the image forming apparatus 14 in FIG. 1. The image forming apparatus 14 includes a controller 50, storage device 52, image forming device 54, and user interface (UI) 56, network communication unit 58, and radio communication unit 60.

The image forming device 54 includes a reading unit 62, print unit 63, and fax unit 64. The reading unit 62 generates image data by reading a paper sheet. The print unit 63 outputs a printed material in accordance with the image data. The fax unit 64 transmits or receives fax. For example, the UI unit 56 includes a touch panel and hardware buttons and receives an input operation performed by a user.

The network communication unit 58 performs network communication with external devices including the central server 12. The radio communication unit 60 performs radio communication with external devices including the IoT device 18. The “radio communication” include not only radio communication performed using a radio wave but also spatial optical communication using free-space optics (specifically including infrared communication and visible light communication). For example, standards with which the radio communication complies may be Bluetooth low energy (BLE).

The controller 50 includes a processor 50p and memory 50m and controls the elements of the image forming apparatus 14 in coordination. The processor 50p is an arithmetic device including a CPU or a micro-processing unit (MPU). The memory 50m is a non-transitory computer-readable recording medium.

The storage device 52 includes a hard disk drive (HDD) or a solid-state drive (SSD) and stores a variety of data handled by the image forming apparatus 14. Referring to FIG. 3, a data group 66 that is a mass of data collected from the device group 16 is stored on the storage device 52.

FIG. 4 is an electrical block diagram of the central server 12 in FIG. 1. The central server 12 includes a server communication unit 100, server controller 102, and server memory 104.

The server communication unit 100 is a communication interface that transmits or receives an electrical signal to or from an external device. The central server 12 may thus exchange a variety of data with the image forming apparatus 14 or the trusting server 20 via the network 22 (see FIG. 1).

The server controller 102 includes an arithmetic device including a CPU or MPU. By reading and executing a program stored on the server memory 104, the server controller 102 functions as a collection management unit 106 and a data processor 108. The collection management unit 106 manages the radio module 40 that transmits raw data. The data processor 108 performs a variety of pre-processes on the raw data of the unconnected device 30.

The server memory 104 is a non-transitory computer readable recording medium. Referring to FIG. 4, the server memory 104 stores module management information 110 used to manage the radio module 40 and device generation information 112 indicating the raw data that has undergone a desired pre-process.

FIG. 5 illustrates an example of the data structure of the module management information 110 in FIG. 4. The module management information 110 is data in a table format that indicates correspondence relationship of a module ID, date of registration, collection plan, and multi-function apparatus ID. The module ID is identification information including the process ID and sub ID as previously described with reference to FIG. 2. The date of registration indicates date and time on which a registration process of the radio module 40 that is newly installed has been completed. The collection plan indicates scheduling for a “read” request and a “send” request. The multi-function apparatus ID indicating the identification information of the image forming apparatus 14 may be a serial number or a management number that is separately assigned thereto.

The configuration of the data collection system 10 of the exemplary embodiment has been described above. The process performed by the data collection system 10 is described with reference to BLE communication. The process is divided into three phases, namely, phase 1 performed when the radio module 40 is installed, phase 2 performed when the raw data is read, and phase 3 performed when the raw data is simultaneously transmitted.

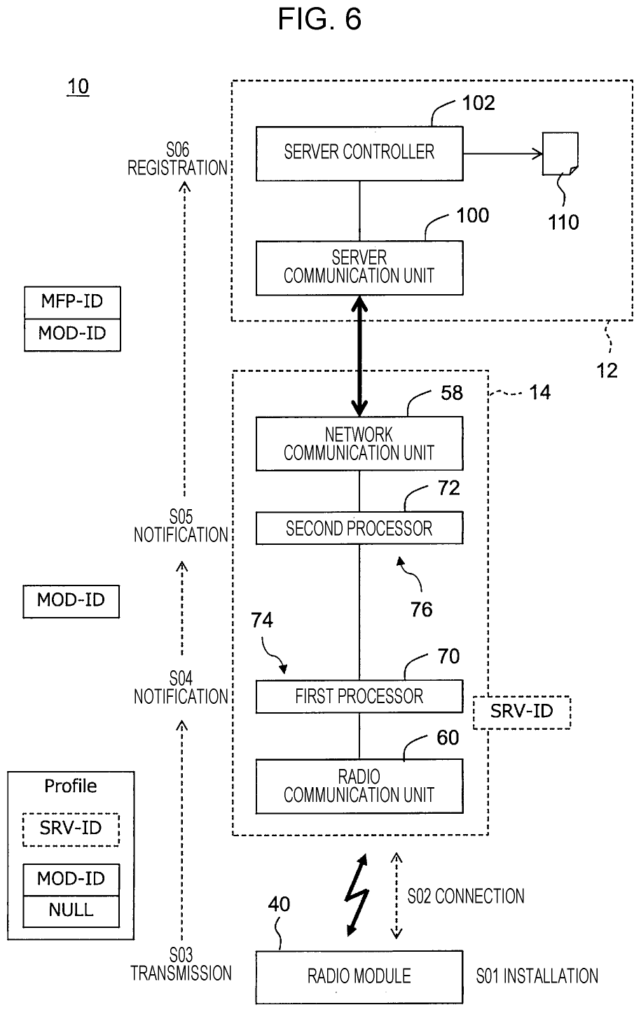

FIG. 6 diagrammatically illustrates a data flow when the radio module 40 is installed. The processor 50p in the image forming apparatus 14 reads a program for a data collection service from the memory 50m and executes the program, thereby functioning as a first processor 70 and a second processor 72. Each of the first processor 70 and second processor 72 may be a software product (such as plugin) commonly used by multiple radio modules 40. As described later, the radio communication unit 60 and the first processor 70 function as a hub unit 74 that collects data from one or more radio modules 40. The network communication unit 58 and second processor 72 function as a transmitting unit 76 that transmits the collected raw data to outside.

Step S01: Prior to the installation, the process ID corresponding to the unconnected device 30 is written and thus stored on the memory 44 in the radio module 40. The user installs the radio module 40 on the input and output port 36 (see FIG. 2) in the unconnected device 30. The radio module 40 then starts simultaneously transmitting advertisement packets including UUID indicating the collection agency service (This operation corresponds to an “advertise mode”).

Step S02: The first processor 70 in the image forming apparatus 14 reads a service UUID included in the advertisement packet received from the radio module 40 and detects the presence of the radio module 40 that is able to provide the collection agency service (This operation corresponds to a “scan” mode). The first processor 70 then requests the radio module 40 enabled to provide the collection agency service to connect to the image forming apparatus 14 and starts the GATT communication with the image forming apparatus 14.

Step S03: In response to a command from the first processor 70 (specifically, a read command for UUID of the first GATT characteristic), the radio module 40 transmits to the image forming apparatus 14 a value responsive to the first GATT characteristic (namely, the module ID).

Step S04: The first processor 70 reads the module ID from the data from the radio module 40 and notifies the second processor 72 of the newly acquired module ID.

Step S05: The second processor 72 in the image forming apparatus 14 performs control to generate a notification message including the module ID notified by the first processor 70 and the multi-function apparatus ID of the image forming apparatus 14 and to transmit the notification message to the central server 12.

Step S06: The server controller 102 in the central server 12 receives the notification message from the image forming apparatus 14 and adds the ID information to the module management information 110. In this way, the newly installed radio module 40 is registered as a module enabled to collect the raw data. In this way, the installation of the radio module 40 is complete.

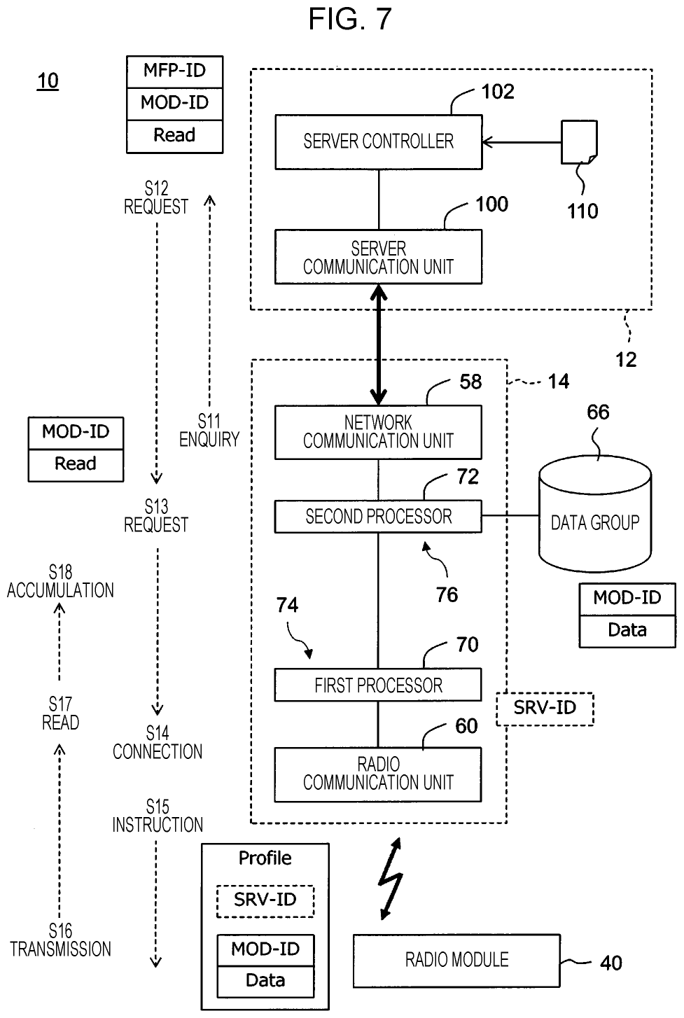

FIG. 7 diagrammatically illustrates the data flow when the raw data is read.

Step S11: The second processor 72 in the image forming apparatus 14 performs control to periodically or non-periodically generate an enquiry message including the multi-function apparatus ID and transmit the enquiry message to the central server 12.

Step S12: The server controller 102 in the central server 12 identifies a module ID associated with the multi-function apparatus ID and serving as a read target by referencing a collection plan of the module management information 110. The server controller 102 performs control to generate a read request message including the module ID and the multi-function apparatus ID and to transmit the request message to the image forming apparatus 14 having the multi-function apparatus ID.

Step S13: After receiving the read request message from the central server 12, the second processor 72 in the image forming apparatus 14 makes the read request to the first processor 70 and notifies the first processor 70 of the module ID included in the request message.

Step S14: The first processor 70 in the image forming apparatus 14 connects to the radio module 40 having the module ID in accordance with operations similar to steps S01 and S02 in FIG. 6.

Step S15: The first processor 70 issues a read command for UUID of the second GATT characteristic to the radio module 40 having connection established.

Step S16: In response to a command from the first processor 70, the radio module 40 transmits to the image forming apparatus 14 the value responsive to the second GATT characteristic (namely, the raw data indicated by a signal from the unconnected device 30).

Step S17: The first processor 70 acquires the raw data indicated by a data string of the second GATT characteristic by issuing the read command with the UUID of the second GATT characteristic specified. The first processor 70 transfers to the second processor 72 the acquired raw data with the module ID associated therewith.

Step S18: The second processor 72 accumulates as the data group 66 the raw data transferred from the first processor 70. The reading of the raw data is thus successively performed.

In response to the request from the central server 12, the image forming apparatus 14 collects the raw data from the radio module 40. The collection method of the raw data is not limited to this method. For example, the first processor 70 in the image forming apparatus 14 may issue to the radio module 40 a “notify” command for the UUID of the second GATT characteristic. The first processor 70 thus reads the raw data in response to a notification from the radio module 40 when the raw data is modified and the first processor 70 thus collects the raw data.

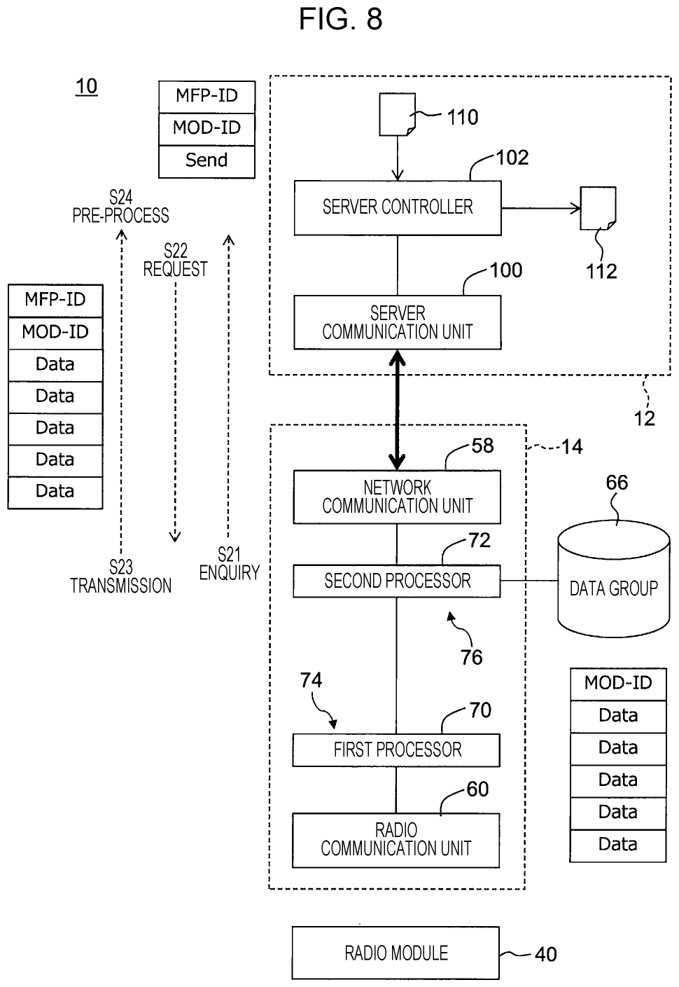

FIG. 8 diagrammatically illustrates a data flow when the raw data is simultaneously transmitted.

Step S21: The second processor 72 in the image forming apparatus 14 performs control to periodically or non-periodically generate an enquiry message including the multi-function apparatus ID and transmit the enquiry message to the central server 12.

Step S22: The server controller 102 in the central server 12 identifies a module ID associated with the multi-function apparatus ID and serving as a send target by referencing the collection plan of the module management information 110. The server controller 102 performs control to generate a send request message including the module ID and the multi-function apparatus ID and transmit the request message to the image forming apparatus 14 having the multi-function apparatus ID.

Step S23: After receiving the send request from the central server 12, the second processor 72 in the image forming apparatus 14 extracts the raw data associated with the module ID from the data group 66. The second processor 72 performs control to simultaneously transmit a collection of the raw data extracted in the module ID and the multi-function apparatus ID associated therewith.

Step S24: The server controller 102 in the central server 12 receives data from the image forming apparatus 14 and acquires the process ID associated with the data. By performing the pre-process corresponding to the process ID on the raw data, the server controller 102 converts the raw data into the device generation information 112 generated by the unconnected device 30 (for example, in a state controlled by the drive unit 33 or to a measurement value of the sensor 35). The transmission and pre-process of the raw data are thus performed.

The data collection system 10 thus includes the radio module 40, image forming device 54, hub unit 74, image forming apparatus 14, and central server 12. The radio module 40 is detachably mounted on each of the unconnected device 30 not connected to any network and is enabled to transmit via radio communication the raw data that is obtained by reading the signal from the input and output port 36 of the unconnected device 30. The image forming device 54 forms an image. The hub unit 74 collects the raw data from one or more radio modules 40. The image forming apparatus 14 includes the transmitting unit 76 that transmits the collected raw data to outside. The central server 12 acquires the device generation information 112 generated by the unconnected device 30 by performing the pre-process responsive to the unconnected device 30 on the raw data transmitted from the image forming apparatus 14.

The data collection method includes mounting the radio module 40 to the input and output port 36 of the unconnected device 30 (step S01 in FIG. 6), transmitting via radio communication from the radio module 40 the raw data obtained by reading the signal from the input and output port 36 (step S16 in FIG. 7), collecting with the image forming apparatus 14 the raw data from the one or more radio modules 40 (step S18), transmitting the obtained raw data to the central server 12 (step S23 in FIG. 8), and acquiring, with the central server 12, the device generation information 112 by performing the pre-process responsive to the unconnected device 30 on the raw data transmitted from the image forming apparatus 14 (step S24).

The hub unit 74 is arranged to collect the raw data from the radio module 40 that is mounted on each of the unconnected devices 30 that are not connected to any network. The data collection software (the first processor 70) installed on the image forming apparatus 14 and the radio module 40 implemented on each the unconnected device 30 are made on a common design basis. Since the central server 12 performs the pre-process responsive to the unconnected device 30 on the raw data transmitted from the image forming apparatus 14, this configuration is free from development of pre-process software (namely, device driver) for the image forming apparatus 14. Such development typically involves deep knowledge of implementing a device configuration. Man-hour for system development is reduced When the image forming apparatus 14 having the image forming device 54 is used as an edge server than when hardware and software for the data collection are developed for each unconnected device 30.

Each of the radio modules 40 is enabled to store the process ID indicating the identification information of the pre-process and transmits the raw data of the unconnected device 30 with the process ID associated therewith to the image forming apparatus 14. The image forming apparatus 14 is enabled to store a device ID indicating the identification information of the image forming apparatus 14. The image forming apparatus 14 transmits to the central server 12 the raw data of the unconnected device 30 with the device ID and the process ID associated therewith. The central server 12 performs the pre-process responsive to the process ID to the raw data transmitted from the image forming apparatus 14. By storing the process ID appropriate for each of the unconnected devices 30 on the radio module 40 in advance, the process method of the raw data may be shared by the central server 12 and the radio module 40 through checking the process ID. In this way, the processing load on the central server 12 is thus reduced more than when the central server 12 determines a process method by analyzing the raw data.

In response to a request from the central server 12, the image forming apparatus 14 may collect the raw data through the radio communication with the radio module 40. By causing the central server 12 to be involved in the collection of the raw data, the processing load on the image forming apparatus 14 is reduced more when the image forming apparatus 14 manages the collection plane of the raw data.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A data collection system, comprising:
one or more radio modules that are respectively detachably mounted on devices unconnected to a network and are enabled to transmit, via radio communication, raw data that is obtained by reading a signal from an input and output port of each of the devices;
an image forming apparatus including an image forming unit that forms an image, a hub unit that collects the raw data from the one or more radio modules, and a transmitting unit that transmits the collected raw data; and
a central server that collects information generated by the devices by performing a pre-process responsive to each of the devices on the raw data transmitted from the image processing apparatus.

2. The data collection system according to claim 1, wherein each of the radio modules is enabled to store a process identification (ID) serving as identification information of the pre-process and transmits to the image forming apparatus the raw data of each of the devices with the process ID associated thereto,
wherein the image forming apparatus is enabled to store a device ID serving as identification information of the image forming apparatus and transmits to the central server the raw data of each of the devices with the device ID and the process ID associated thereto, and
wherein the central server performs the pre-process corresponding to the process ID on the raw data transmitted from the image forming apparatus.

3. The data collection system according to claim 1, wherein in response to a request from the central server, the image forming apparatus collects the raw data via the radio communication with the radio modules.

4. The data collection system according to claim 2, wherein in response to a request from the central server, the image forming apparatus collects the raw data via the radio communication with the radio modules.

5. A data collection method, comprising:
mounting one or more radio modules to input and output ports of devices unconnected to a network;
transmitting, via radio communication, raw data that is obtained by reading a signal from the input and output port;
collecting raw data from the one or more radio modules and transmitting the raw data obtained to a central server; and
acquiring information generated by the devices by performing a pre-process responsive to the devices on the raw data transmitted.
